(19) United States
(12) Patent Application Publication
(10) Pub. No.: US 2023/0208450 A1
(43) Pub. Date: Jun. 29, 2023

(54) WIRELESS TRANSMISSION DEVICE AND CONTROL METHOD THEREFOR

(71) Applicant: NEC Corporation, Tokyo (JP)

(72) Inventor: Taro TERAMOTO, Tokyo (JP)

(73) Assignee: NEC Corporation, Tokyo (JP)

(21) Appl. No.: 18/086,044

(22) Filed: Dec. 21, 2022

(30) Foreign Application Priority Data
Dec. 27, 2021 (JP) 2021-213003

(51) Int. Cl. H04B 1/00; H04W 52/36

(52) U.S. Cl. CPC H04B 1/0053; H04W 52/367

(57) ABSTRACT

A wireless transmission device includes at least: a modulator to which the input signals of the plurality of channels are input; and a transmitter that includes a power amplifier and transmits a signal output by the modulator from the antenna. When it is necessary to increase output power of a signal associated to one input signal among the input signals of the plurality of channels and transmitted from the antenna, reserve power up to a maximum value of output power of another input signal among the input signals of the plurality of channels is checked. A control signal is supplied with the transmitter or the modulator so as to increase output power of a signal associated to the one input signal within a range of the reserve power and transmitted from the antenna.

This application is based upon and claims the benefit of priority from Japanese Patent Application No. 2021-213003, filed on Dec. 27, 2021, the disclosure of which is incorporated herein in its entirety by reference.

### TECHNICAL FIELD

The present invention relates to a wireless transmission device and a control method thereof, and particularly relates to control of transmission power thereof.

### BACKGROUND ART

As a wireless transmission device, there is a microwave digital wireless communication system that transmits and receives a plurality of wireless channels (hereinafter, CH) by one antenna. As such a microwave digital wireless communication system, a system configuration in which a modulator (hereinafter, MOD) and a transmitter (hereinafter, Tx) are combined for a plurality of CHs is general. In this system configuration, since the Tx of the single carrier transmission system is collected for a plurality of CHs, the transmission power control of the wireless transmission device is independently performed for each CH.

On the other hand, in recent years, with the development of electronic devices, a system configuration in which one power amplifier (hereinafter, PA) is shared by a plurality of CHs has been considered in a microwave digital wireless communication system.

WO 2015/015678 A relates to transmission power control of a wireless communication device, and describes that transmission power in a transmission station is controlled in order to suppress a decrease in reception power in a reception station due to deterioration of a state of a wireless transmission path (deterioration caused by, for example, rainfall or the like). WO 2015/015678 A describes that there is an ATPC (automatic transmit power control) as a control method of the transmission power, and that in the ATPC, a receiving station (determination station) controls the transmission power in a transmitting station (control station) by comparing the reception power with a predetermined power control determination threshold.

WO 2015/015678 A describes the control when the reception power of a radio signal received from another wireless communication device is smaller than a power control determination threshold for controlling the transmission power in the other wireless communication device. In WO 2015/015678 A, in this case, it is proposed to determine whether the current modulation scheme can be switched to the higher modulation scheme based on the reception power and the excess value. Further, in WO 2015/015678 A, it is proposed to control the transmission power so as to suppress the transmission power in other wireless communication devices so that the reception power becomes quality assurance power that guarantees the communication quality in the current modulation scheme when it is determined that switching is impossible.

JP 2014-535245 A relates to a communication system including a radio access network (RAN) and a plurality of radio transmission/reception units (WTRU) wirelessly communicating with the RAN, and describes that the WTRU scales transmission power of a channel. JP 2014-535245 A describes that the WTRU can determine the power of each channel to be transmitted. JP 2014-535245 A describes that the WTRU can scale the transmission power of the channel such that the sum of the transmission powers is expected not to exceed, or does not exceed the configured maximum output power of the WTRU.

Here, it is assumed that ATPC (automatic transmit power control) is applied in a microwave digital wireless communication system having a system configuration in which one power amplifier is shared by a plurality of CHs.

In a case of a system configuration in which a PA is shared by a plurality of CHs, signals of the plurality of CHs are added to each other before input to the PA, and thus, a peak factor (a ratio of peak power to average power of a modulation signal) is increased as compared with a case of single carrier transmission.

Therefore, since it is necessary to take a large backoff, it is also necessary to lower the maximum value of the transmission power in each CH as compared with the single carrier transmission (see FIG. 17).

In the case of a system configuration in which one PA is shared by a plurality of CHs, there is an advantage that power consumption of the system can be reduced because one PA can be covered without using a plurality of CHs.

On the other hand, it is necessary to lower the maximum value of the transmission power in each CH due to an increase in the required backoff accompanying the addition of the signals of the plurality of CHs. However, in the ATPC that performs transmission power control independently for each CH, when there is a difference in transmission power between CHs, there is a problem that the input level of each CH cannot be optimized with respect to the input level condition of the PA, and the performance of the PA cannot be maximized.

### SUMMARY

An object of the present invention is to provide a wireless transmission device capable of optimizing transmission power of each wireless channel in a case where a plurality of wireless channels having different frequency bands is transmitted by one antenna, and a control method thereof.

In order to achieve the above object, a wireless transmission device according to the present invention is a wireless transmission device that converts input signals of a plurality of channels into signals of high frequency bands having different frequency bands from each other and then transmits the signals from one antenna, the wireless transmission device includes at least: a modulator to which the input signals of the plurality of channels are input; and a transmitter that includes a power amplifier and transmits a signal output by the modulator from the antenna, wherein when it is necessary to increase output power of a signal associated to one input signal among the input signals of the plurality of channels and transmitted from the antenna, reserve power up to a maximum value of output power of another input signal among the input signals of the plurality of channels is checked, and a control signal is provided to the transmitter or the modulator so as to increase output power of a signal associated to the one input signal within a range of the reserve power and transmitted from the antenna.

A control method of a wireless transmission device according to the present invention converts input signals of a plurality of channels into signals of high frequency bands having different frequency bands from each other and then transmits the signals from one antenna, the wireless transmission device includes at least: a modulator to which the input signals of the channels are input; and a transmitter that includes a power amplifier and transmits a signal output by the modulator from the antenna, wherein when it is necessary to increase output power of a signal associated to one input signal among the input signals of the plurality of channels and transmitted from the antenna, reserve power up to a maximum value of output power of another input signal among the input signals of the plurality of channels is checked, and the transmitter or the modulator is controlled so as to increase output power of a signal associated to the one input signal within a range of the reserve power and transmitted from the antenna.

According to the present invention, in a wireless transmission device that transmits a plurality of wireless channels having different frequency bands with one antenna, transmission power control is performed in cooperation between a plurality of CHs to optimize transmission power of each CH, thereby maximizing the performance of the PA and improving the reception characteristics of the entire system.

### BRIEF DESCRIPTION OF THE DRAWINGS

Exemplary features and advantages of the present invention will become apparent from the following detailed description when taken with the accompanying drawings in which:

FIG. 1 is a block diagram for describing a wireless transmission device according to an example embodiment of a superordinate concept of the present invention;

FIG. 2 is a block diagram for describing a wireless transmission device according to a first example embodiment of the present invention;

FIG. 3A is a graph illustrating a relationship between a channel and a frequency band of one baseband signal input to the wireless transmission device in FIG. 2;

FIG. 3B is a graph illustrating a relationship between a channel and a frequency band of another baseband signal input to the wireless transmission device in FIG. 2;

FIG. 3C is a graph illustrating a relationship between a channel and a frequency band of an intermediate frequency signal of the wireless transmission device in FIG. 2;

FIG. 3D is a graph illustrating a relationship between a channel and a frequency band of a radio frequency signal of the wireless transmission device in FIG. 2;

FIG. 4 is a block diagram illustrating a specific configuration of a transmitter included in the wireless transmission device of FIG. 2.

FIG. 5A is a block diagram for describing an operation of a wireless communication system including the wireless transmission device of FIG. 2;

FIG. 5B is a conceptual diagram for describing a case where cooperation between channels is not performed in transmission power control of the wireless communication system of FIG. 5A;

FIG. 5C is a conceptual diagram for describing a case where cooperation between channels is not performed in transmission power control of the wireless communication system of FIG. 5A;

FIG. 6A is a block diagram for describing an operation of the wireless communication system including the wireless transmission device of FIG. 2;

FIG. 6B is a conceptual diagram for describing an operation in a case where cooperation between channels is performed in transmission power control of the wireless communication system of FIG. 5A;

FIG. 7A is an example of a table referred to in the transmission power control of the example embodiment;

FIG. 7B is a graph for describing an operating point of an amplifier in a case where cooperation between channels is performed in transmission power control of the wireless communication system of FIG. 5A;

FIG. 8A is a block diagram for describing an example of a more detailed configuration of the wireless communication system of FIG. 6A;

FIG. 8B is a block diagram for describing an example of a more detailed configuration of the wireless communication system of FIG. 6A;

FIG. 9A is a flowchart for describing transmission power control of the wireless communication system of FIG. 5A;

FIG. 9B is a flowchart for describing transmission power control of the wireless communication system of FIG. 5A;

FIG. 10 is a block diagram for describing a configuration example of a transmitter of a wireless transmission device according to a second example embodiment of the present invention;

FIG. 11 is a block diagram illustrating an example of a wireless transmission device of the background art;

FIG. 12A is a graph illustrating a relationship between a channel and a frequency band of one baseband signal input to the wireless transmission device in FIG. 11;

FIG. 12B is a graph illustrating a relationship between a channel and a frequency band of another baseband signal input to the wireless transmission device in FIG. 11;

FIG. 12C is a graph illustrating a relationship between a channel and a frequency band of an intermediate frequency signal of the wireless transmission device in FIG. 11;

FIG. 12D is a graph illustrating a relationship between a channel and a frequency band of an intermediate frequency signal of the wireless transmission device in FIG. 11;

FIG. 12E is a graph illustrating a relationship between a channel and a frequency band of a radio frequency signal of the wireless transmission device in FIG. 11;

FIG. 13A is a block diagram illustrating a configuration example of one transmitter in FIG. 11;

FIG. 13B is a block diagram illustrating a configuration example of another transmitter in FIG. 11;

FIG. 14 is a block diagram illustrating another configuration example of the wireless transmission device of the background art;

FIG. 15A is a graph illustrating a relationship between a channel and a frequency band of one baseband signal input to the wireless transmission device in FIG. 14;

FIG. 15B is a graph illustrating a relationship between a channel and a frequency band of another baseband signal input to the wireless transmission device in FIG. 14;

FIG. 15C is a graph illustrating a relationship between a channel and a frequency band of an intermediate frequency signal of the wireless transmission device in FIG. 14;

FIG. 15D is a graph illustrating a relationship between a channel and a frequency band of a radio frequency signal of the wireless transmission device in FIG. 14;

FIG. 16 is a block diagram illustrating a configuration example of the transmitter in FIG. 14; and

FIG. 17 is a graph illustrating operating points of the amplifier of the transmitter of FIG. 14.

### EXAMPLE EMBODIMENT

Before describing an example embodiment of the present invention, the background art of the present invention and problems thereof will be described with reference to the drawings.

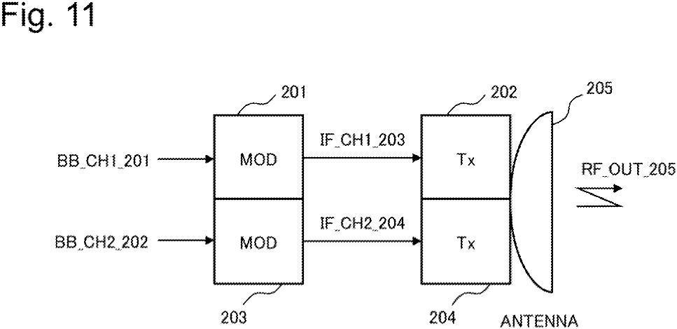

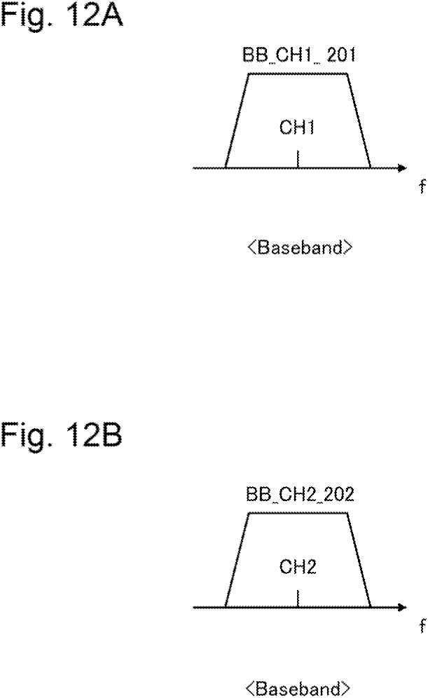

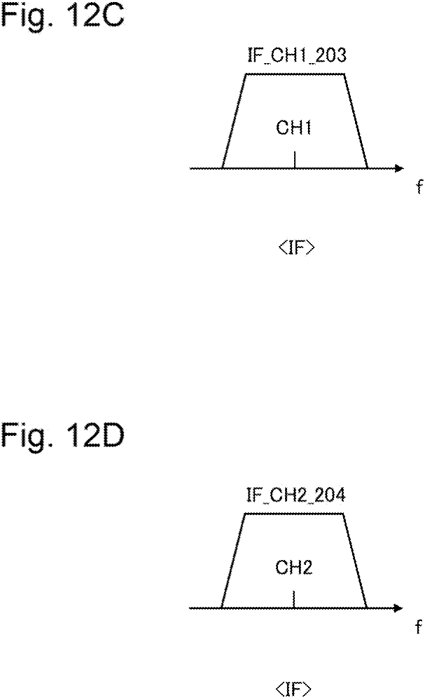

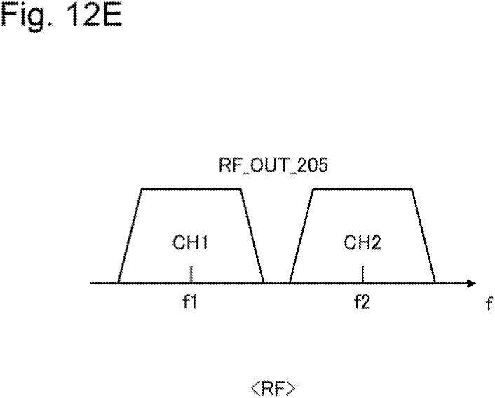

In a microwave digital wireless communication system in which a plurality of radio CHs are transmitted and received by one antenna, as illustrated in FIG. 11, a system configuration in which a modulator (Modulator, hereinafter MOD) and a transmitter (Transmitter, hereinafter Tx) are combined for the plurality of CHs is general. Here, as an example, a two-wave system configuration is illustrated. The wireless communication system of FIG. 11 includes modulators 201 and 203, transmitters 202 and 204, and an antenna 205. FIG. 12A illustrates a relationship between a channel CH1 and a frequency band of one baseband signal (BB_CH1_201) input to the wireless transmission device in FIG. 11. FIG. 12B illustrates a relationship between a channel CH2 and a frequency band of another baseband signal (BB_CH2_202) input to the wireless transmission device in FIG. 11. FIG. 12C illustrates a relationship between the channel CH1 of one intermediate frequency signal (IF_CH1_203) and the frequency band in the wireless transmission device in FIG. 11. FIG. 12D illustrates a relationship between the channel CH2 and the frequency band of another intermediate frequency signal (IF_CH2_204) of the wireless transmission device in FIG. 11. FIG. 12E illustrates a relationship between the channel (CH1, CH2) of the radio frequency signal (RF_OUT_205) and the frequency band (f1, f2) in the wireless transmission device of FIG. 11.

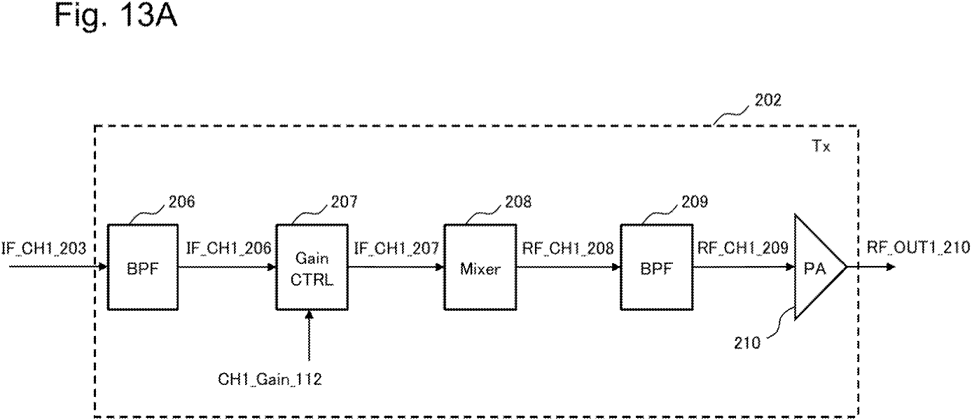

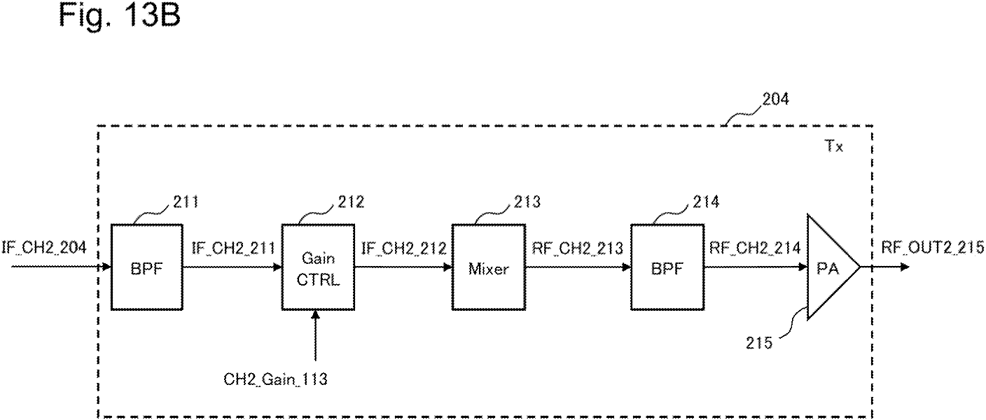

In this system, since the Tx of the single carrier transmission system as illustrated in FIGS. 13A and 13B is collected for the plurality of CHs, the transmission power control is independently performed for each CH. The transmitter 202 in FIG. 13A includes a bandpass filter 206 (BPF 206), a gain controller 207, a mixer 208, a bandpass filter 209 (BPF 209), and a power amplifier 210 (PA 210). The transmitter 204 in FIG. 13B includes a bandpass filter 211 (BPF 211), a gain controller 212, a mixer 213, a bandpass filter 214 (BPF 214), and a power amplifier 215 (PA 215).

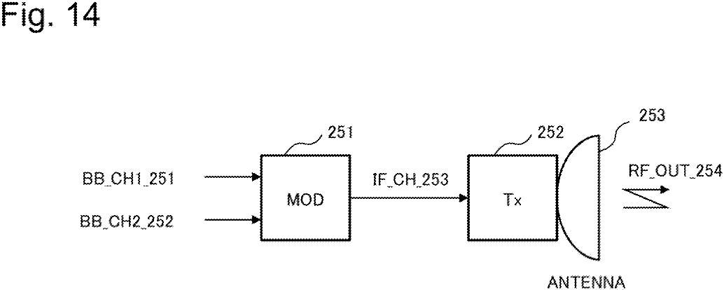

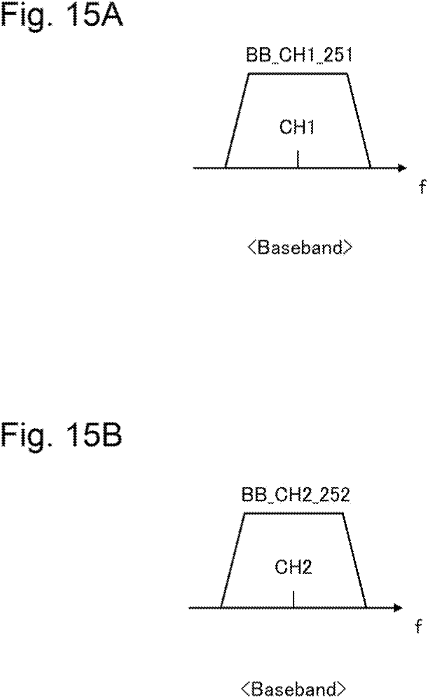

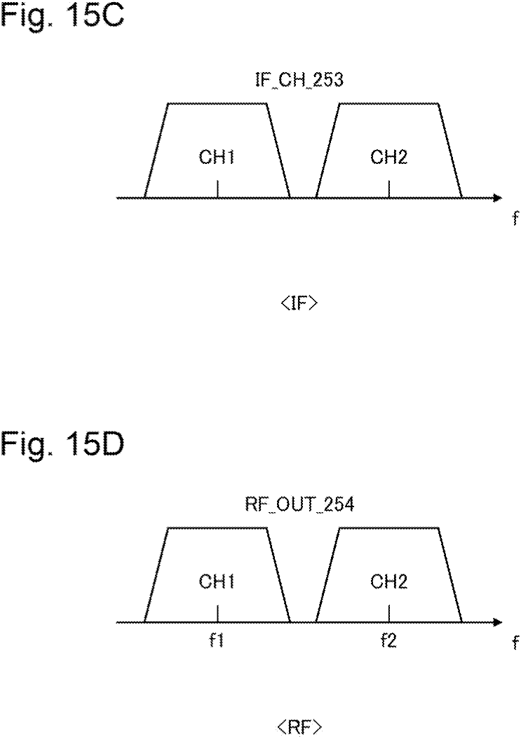

On the other hand, in recent years, with the development of electronic devices, a system configuration as illustrated in FIG. 14 is also considered. The wireless communication system of FIG. 14 includes a modulator 251 that receives input signals of a plurality of CHs, a transmitter 252, and an antenna 253. FIG. 15A illustrates a relationship between a channel CH1 and a frequency band of one baseband signal (BB_CH1_251) input to the wireless transmission device in FIG. 14. FIG. 15B illustrates a relationship between a channel CH2 and a frequency band of another baseband signal (BB_CH2_252) input to the wireless transmission device in FIG. 14. FIG. 15C illustrates the relationship between the channel (CH1, CH2) of the intermediate frequency signal (IF_CH_253) and the frequency band of the wireless transmission device in FIG. 14. FIG. 15D illustrates a relationship between the channel (CH1, CH2) of the radio frequency signal (RF_OUT_254) and the frequency band (f1, f2) in the wireless transmission device of FIG. 14.

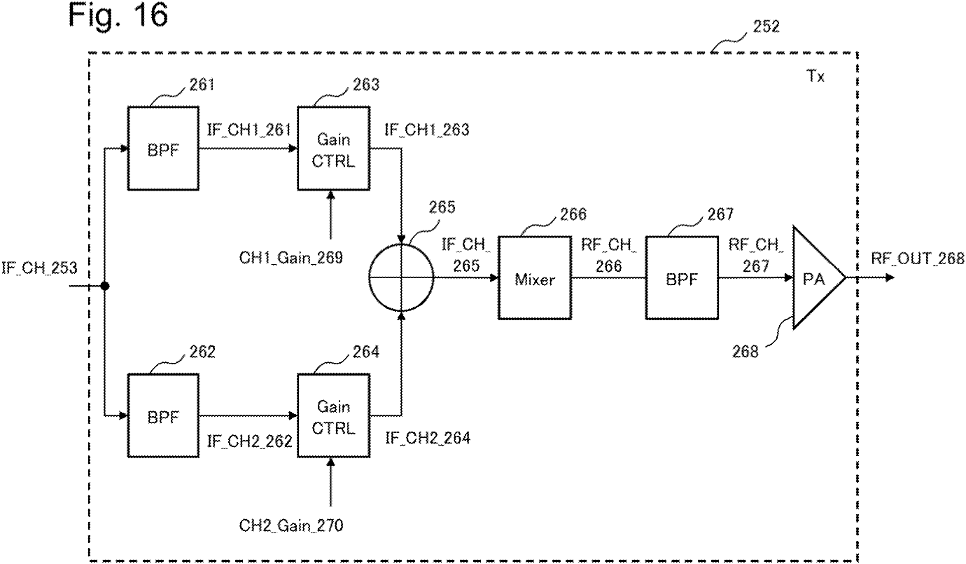

FIG. 16 illustrates a configuration example of the transmitter in FIG. 14. The transmitter 252 in FIG. 16 includes a band pass filter 261 (BPF 261), a band pass filter 262 (BPF 262), gain controllers 263 and 264, a multiplexer 265, a mixer 266, a band pass filter 267 (BPF 267), and a power amplifier 268 (PA 268).

The Tx (transmitter 252) in the wireless communication system illustrated in FIG. 14 has a configuration in which the PA (power amplifier 268) is used in common for each CH as illustrated in FIG. 16, but also in this case, the transmission power control is independently performed for each CH.

In a case of a system configuration in which the PA (power amplifier 268) is shared by a plurality of CHs as illustrated in FIG. 16, signals of the plurality of CHs are added to each other before an input to the PA (power amplifier 268), and thus, a peak factor increases as compared with a case of single carrier transmission. Here, the “peak factor” is defined as a ratio of the peak power to the average power of the modulation signal.

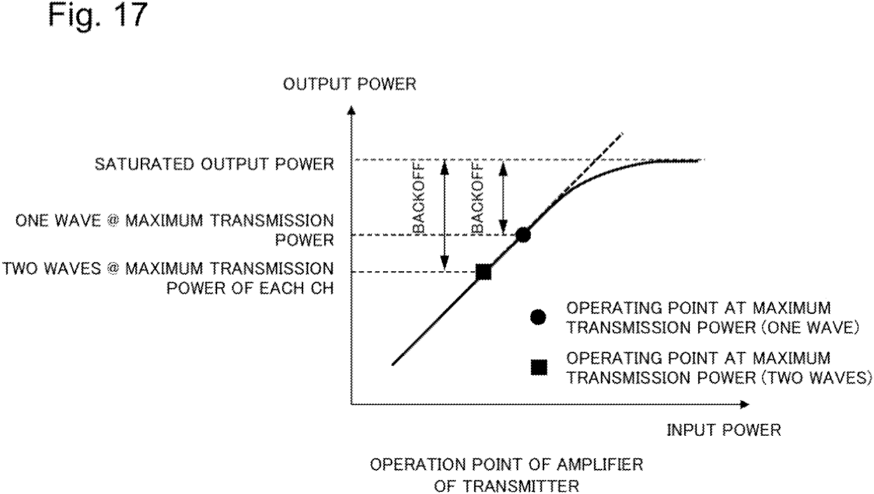

Therefore, since it is necessary to take a large backoff, it is also necessary to lower the maximum value of the transmission power in each CH as compared with the single carrier transmission. Referring to FIG. 17, during the single carrier transmission, the operating point at the maximum transmission power (one wave) is one wave @ the transmission power maximum value indicated by the symbol “•” (Black Circle). On the other hand, in the case of a system configuration in which the PA (power amplifier 268) is shared by the plurality of CHs, it is necessary to take a large backoff at the operating point at the maximum transmission power (two waves) as two waves @ the transmission power maximum value at each CH as indicated by the symbol “▪” (Black Square) in FIG. 17.

In the case of a system configuration in which one PA (power amplifier 268) is shared by the plurality of CHs as illustrated in FIG. 14, there is an advantage that power consumption of the system can be reduced because one PA can be covered without using the plurality of CHs.

On the other hand, there is a constraint that it is necessary to lower the maximum value of the transmission power in each CH due to an increase in the required backoff accompanying the addition of the signals of the plurality of CHs. In the transmission power control in which the transmission power control is independently performed for each CH, when there is a difference in the transmission power between CHs, there is a problem that the input level of each CH cannot be optimized with respect to the input level condition of the PA, and the performance of the PA cannot be maximized.

### Example Embodiment of Superordinate Concept

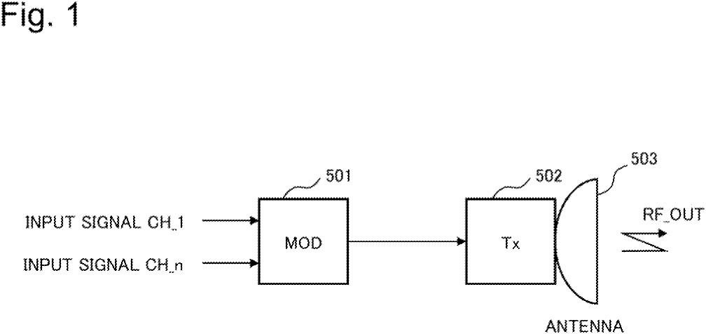

First, a wireless transmission device and a control method thereof according to an example embodiment of a superordinate concept of the present invention will be described. FIG. 1 is a block diagram for describing a wireless transmission device according to an example embodiment of a superordinate concept of the present invention.

The wireless transmission device of FIG. 1 transmits a plurality of wireless channels by one antenna. The wireless transmission device of FIG. 1 includes a modulator 501 to which a plurality of input signals (CH_1 to CH_n) are input, a transmitter 502 having a power amplifier, and an antenna 503. The plurality of input signals (CH_1 to CH_n) are associated to the plurality of radio channels. In the wireless transmission device of FIG. 1, the input signals of the plurality of channels in a base band (BB) frequency band or an intermediate frequency (IF) frequency band are converted into signals in a high frequency band and transmitted from the one antenna 503 as a transmission signal (RF_OUT).

Further, in the wireless transmission device of FIG. 1, when it is necessary to increase the output power of the transmission signal associated to one input signal among the input signals of the plurality of channels and transmitted from the one antenna 503, the transmission power of the transmission signal is controlled so as to decrease the output power of another input signal among the input signals of the plurality of channels. In other words, the transmission power of the transmission signal is controlled so as to decrease the output power of another input signal among the input signals of the plurality of channels and increase the output power of the transmission signal associated to one input signal and transmitted from the one antenna 503.

In the wireless transmission device of FIG. 1, the gain of the power amplifier included in the transmitter 502 can be optimized for the input signal of each channel by the transmission power control of the above-described aspect. For example, for a signal of one channel associated to one input signal, the output power can be increased for a signal of one channel associated to the one input signal by reducing the output power to the extent that the wireless communication quality can be maintained for a signal of a channel associated to another one input signal.

As described above, in the transmission signal transmitted from one antenna 503, the transmission power of each channel can be optimized by performing transmission power control in cooperation among a plurality of channels. In this way, the performance of the power amplifier included in the transmitter 502 can be maximized, and the reception characteristics of the entire system including the wireless transmission device can be improved. Hereinafter, more specific example embodiments will be described in detail.

### First Example Embodiment

Next, a wireless transmission device and a control method thereof according to a first example embodiment of the present invention will be described. In the present example embodiment, a case where transmission power is controlled in the IF frequency band will be described as an example.

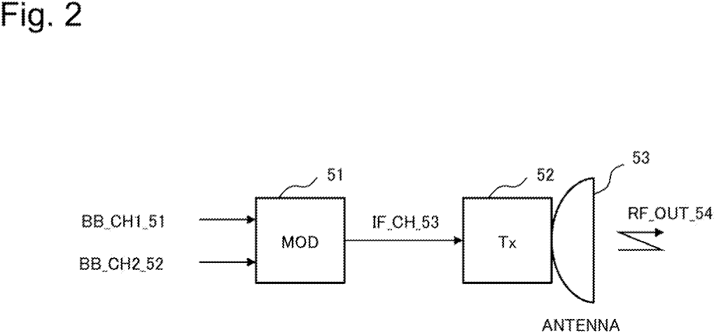

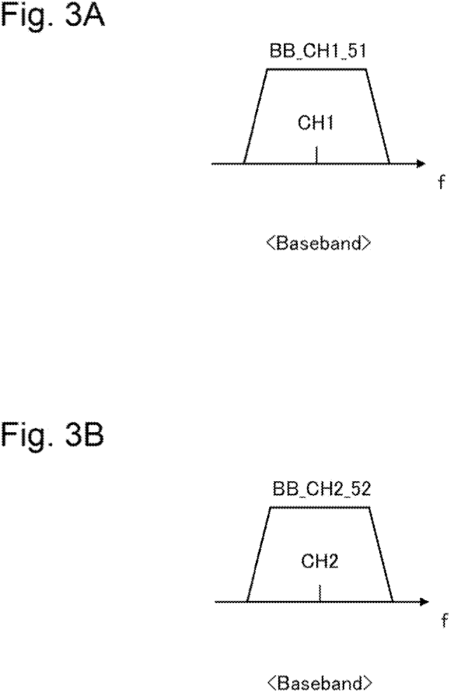

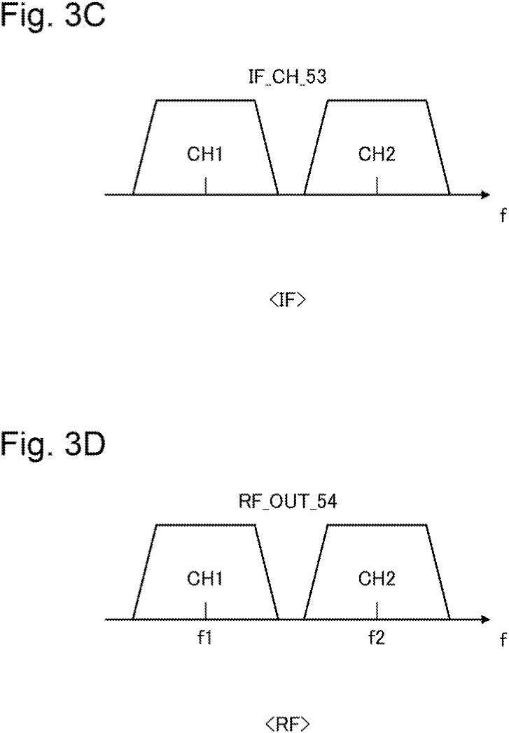

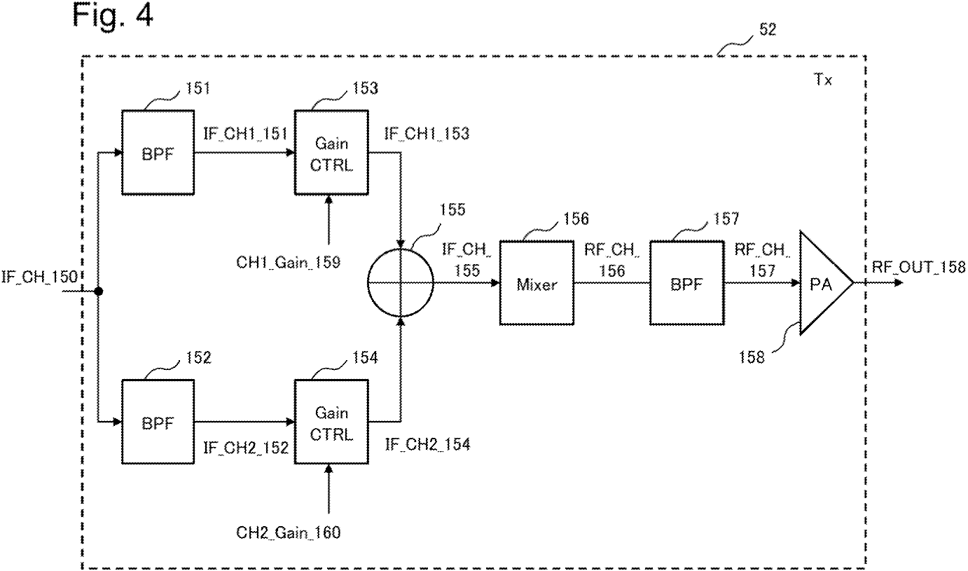

FIG. 2 is a block diagram for describing the wireless transmission device according to the first example embodiment of the present invention. FIG. 3A is a graph illustrating a relationship between a channel and a frequency band of one baseband signal input to the wireless transmission device in FIG. 2. FIG. 3B is a graph illustrating a relationship between a channel and a frequency band of another baseband signal input to the wireless transmission device in FIG. 2. FIG. 3C is a graph illustrating a relationship between a channel and a frequency band of an intermediate frequency signal of the wireless transmission device in FIG. 2. FIG. 3D is a graph illustrating a relationship between a channel and a frequency band of a radio frequency signal of the wireless transmission device in FIG. 2.

The present example embodiment relates to a microwave digital wireless communication system that transmits and receives a plurality of radio channels by one antenna. In the present example embodiment, it is assumed that a plurality of channels are transmitted by one wireless transmission device (MOD 51 and Tx 52) as illustrated in FIG. 2. As understood from FIG. 3D, in the wireless transmission device of FIG. 2, a plurality of wireless channels (CH1, CH2) having different frequency bands are transmitted by one antenna 53.

The wireless transmission device of FIG. 2 includes a modulator 51 (MOD) to which a plurality of input signals (BB_CH1_51, BB_CH1_52) is input, a transmitter 52 (Tx) having a power amplifier, and an antenna 53. The modulator 51 in FIG. 2 adds a plurality of input signals (BB_CH1_51, BB_CH1_52) in the baseband to generate and output an IF signal (IF_CH_53). The transmitter 52 includes a power amplifier, converts an input IF signal (IF_CH_53) into a high frequency band, amplifies the converted IF signal by the power amplifier, and outputs the amplified and converted IF signal. The antenna 53 transmits the output of the transmitter 52 as a transmission signal (RF_OUT_54) to an opposing wireless transmission device (not illustrated).

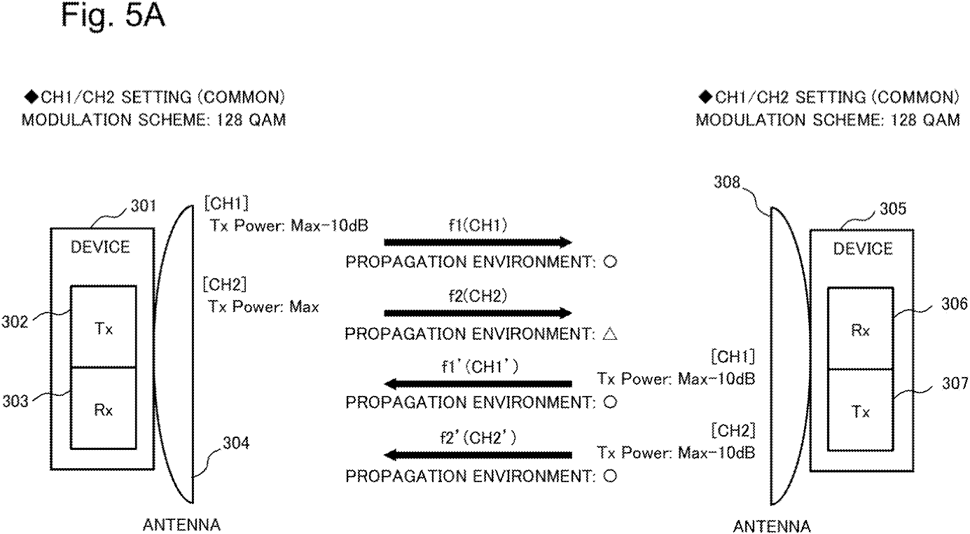

A configuration example of the transmitter 52 (Tx) of the present example embodiment will be described with reference to FIG. 4. The transmitter 52 (Tx) in FIG. 4 includes a band-pass filter 151 (BPF 151), a band-pass filter 152 (BPF 152), gain controllers 153 and 154, an adder 155, a mixer 156, a band-pass filter 157 (BPF 157), and a power amplifier 158 (PA 158).

The BPF 151 and the BPF 152 pass only the signal of the frequency band of each channel for the input IF signal (IF_CH_150). The gain controllers 153 and 154 perform level control of transmission power according to an input control signal (CH1_Gain_159 in the gain controller 153 and CH2_Gain_160 in the gain controller 154). The adder 155 adds the IF signals (IF_CH1_153, IF_CH2_154) associated to each channel in which the level of the transmission power is adjusted by the gain controllers 153 and 154. The mixer 156 converts the output signal (IF_CH_155) of the adder 155 from the IF band to the RF band. The BPF 157 passes only a signal of a desired frequency band. The power amplifier 158 is, for example, a high-output analog power amplifier, and amplifies and outputs the RF signal (RF_CH_157) from the BPF 157.

The IF signal (IF_CH_150) input to the transmitter 52 (Tx) is separated into signals (IF_CH1_151 and IF_CH2_152) in the respective frequency bands of CH1 and CH2 by the BPF 151 and the BPF 152.

Next, the level control of the transmission power of CH1 and CH2 is performed by the control signal (CH1_Gain159, CH2_Gain160) calculated based on the current transmission power of CH1 and CH2, and the signals of CH1 and CH2 are added by the adder 155.

Next, after conversion from the IF band to the RF band by the mixer 156, only a signal in a predetermined frequency band is extracted by the BPF 157, amplified to RF_CH_157 by the power amplifier 158 (PA 158), and emitted from the antenna 53 as a radio wave.

### Operation of Example Embodiment

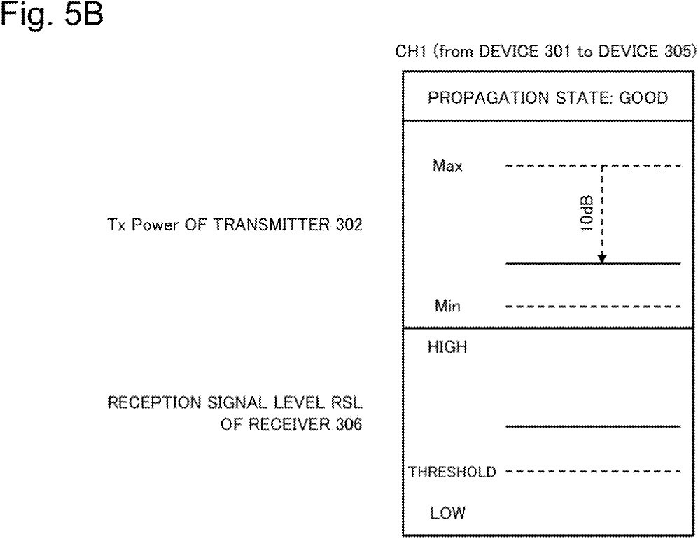

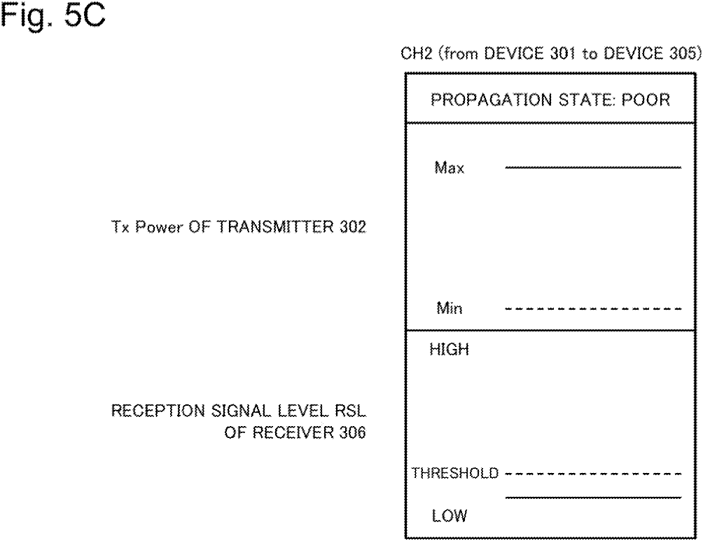

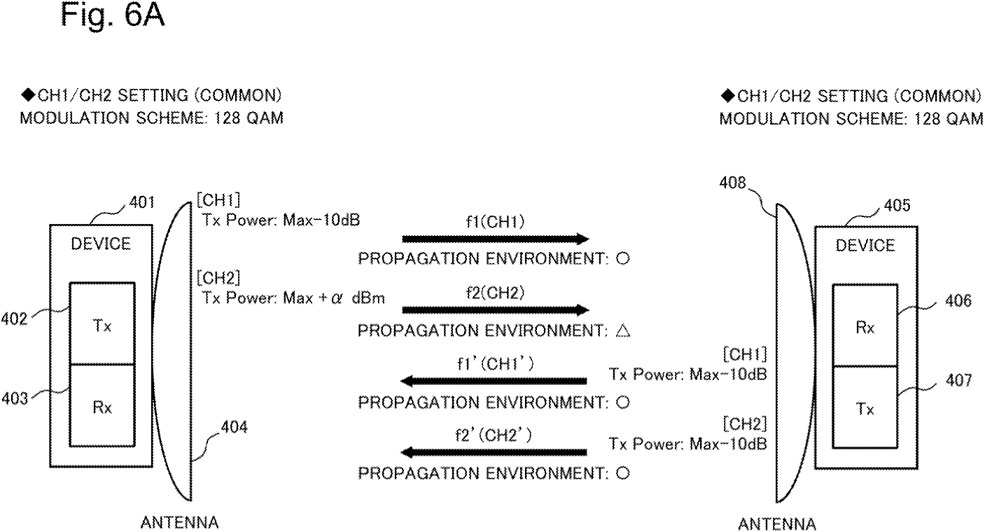

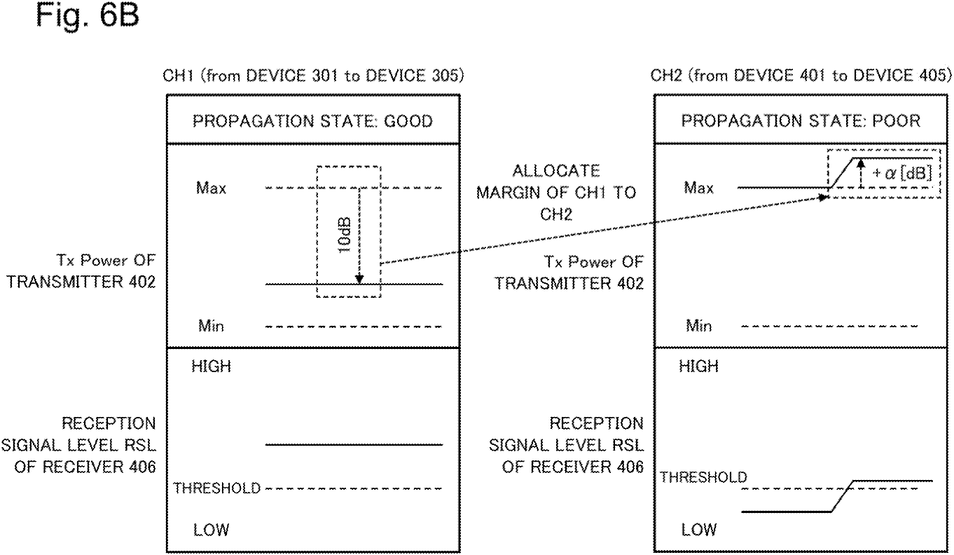

Next, transmission power control of the wireless transmission device according to the present example embodiment will be schematically described with reference to FIGS. 5A to 5C, 6A, and 6B.

FIGS. 5A to 5C illustrate an operation example without cooperation between CHs in automatic transmit power control (ATPC), and FIGS. 6A and 6B illustrate an operation example with cooperation between CHs in ATPC, both of which have 2 CHs configuration (two-channel configuration) of CH1 and CH2. In the wireless transmission device of the present invention, the number of channels of the input signal is not limited to two, and may be three or more.

CH1 and CH2 in the following description of the operation are signals from a wireless transmission device 301 to a wireless transmission device 305 in FIGS. 5A to 5C, and signals from a wireless transmission device 401 to a wireless transmission device 405 in FIGS. 6A and 6B. Here, the description will be given assuming that the wireless transmission devices 301 and 305 include not only a configuration of a transmission function as illustrated in FIG. 2 but also a configuration of a reception function for receiving signals from the opposing wireless transmission devices 305 and 301. The wireless transmission device 301 includes a transmitter 302 (Tx) and a receiver 303 (Rx), and wirelessly transmits and receives signals to and from the opposing wireless transmission device 305 via an antenna 304. The wireless transmission device 305 includes a transmitter 307 (Tx) and a receiver 306 (Rx), and wirelessly transmits and receives signals to and from the opposing wireless transmission device 301 via an antenna 308.

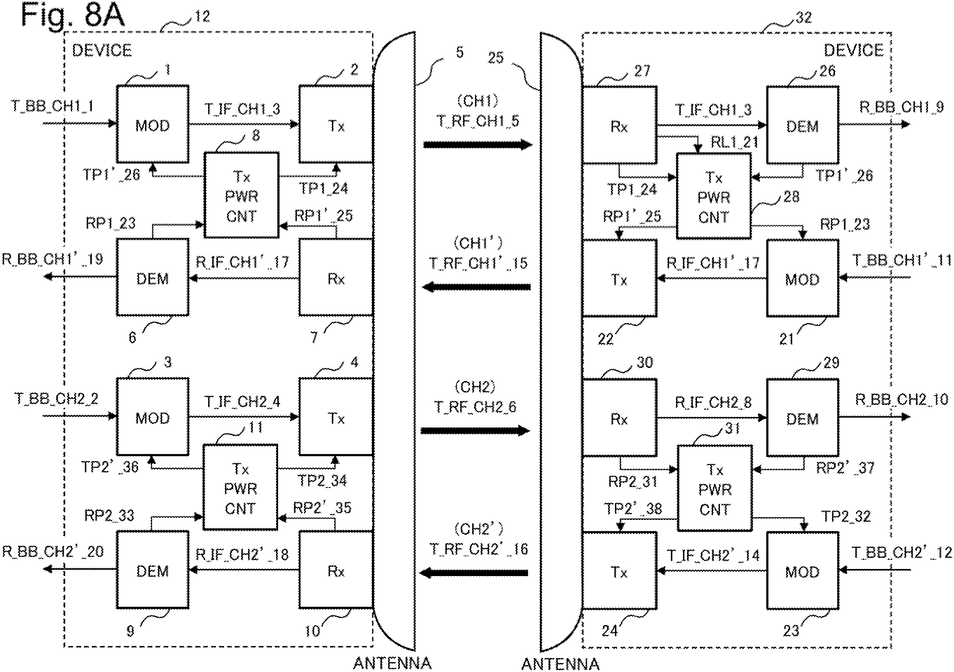

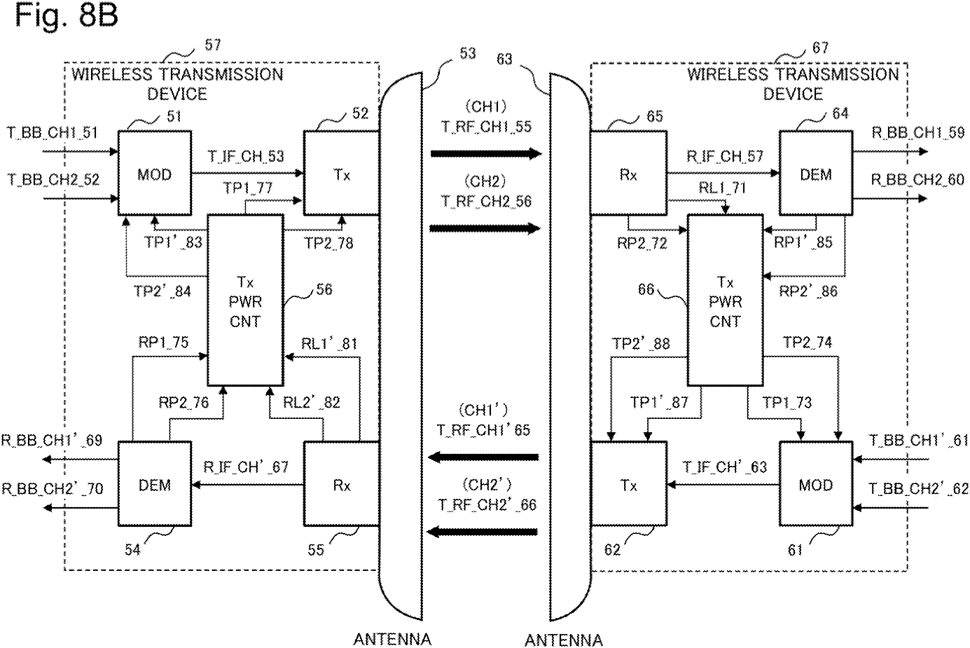

FIG. 8A is a block diagram for describing an example of a more detailed configuration of the wireless communication system of FIG. 5A. The wireless communication system of FIG. 8A includes a modulator 1 (MOD), a transmitter 2 (Tx) having a power amplifier, and an antenna 5. The wireless transmission device 12 of FIG. 8A further includes a receiver 7 (Rx), a demodulator 6 (DEM), and a transmission power controller 8 (Tx PWR CNT). The wireless transmission device 12 of FIG. 8A further includes a modulator 3 (MOD), a transmitter 4 (Tx) having a power amplifier, a receiver 10 (Rx), a demodulator 9 (DEM), and a transmission power controller 11 (Tx PWR CNT). Further, the wireless communication system in FIG. 8A includes an antenna 25 and a wireless transmission device 32. The wireless transmission device 32 of FIG. 8A includes a receiver 27 (Rx), a demodulator 26 (DEM), and a transmission power controller 28 (Tx PWR CNT). The wireless transmission device 32 of FIG. 8A further includes a modulator 21 (MOD) and a transmitter 22 (Tx) having a power amplifier. The wireless transmission device 32 of FIG. 8A further includes a receiver 30 (Rx), a demodulator 29 (DEM), and a transmission power controller 31 (Tx PWR CNT). The wireless transmission device 32 of FIG. 8A further includes a modulator 23 (MOD) and a transmitter 24 (Tx) having a power amplifier.

FIG. 8B is a block diagram for describing an example of a more detailed configuration of the wireless communication system of FIG. 6A. The wireless communication system of FIG. 8B includes the modulator 51 (MOD), the transmitter 52 (Tx) having a power amplifier, and the antenna 53 as in FIG. 2. A wireless transmission device 57 of FIG. 8B further includes a receiver 55 (Rx), a demodulator 54 (DEM), and a transmission power controller 56 (Tx PWR CNT). The wireless communication system in FIG. 8B includes a wireless transmission device 67 and an antenna 63. The wireless transmission device 67 of FIG. 8B includes a receiver 65 (Rx), a demodulator 64 (DEM), and a transmission power controller 66 (Tx PWR CNT). The wireless transmission device 67 of FIG. 8B further includes a modulator 61 (MOD) and a transmitter 62 (Tx) having a power amplifier.

In FIG. 5A, it is assumed that the propagation state of CH1 in the direction from the wireless transmission device 301 to the wireless transmission device 305 is good and the propagation state of CH2 is poor (not good). Although a specific description is omitted, FIG. 5A illustrates a case where the propagation state of CH1 in the direction from the wireless transmission device 305 to the wireless transmission device 301 is good and the propagation state of CH2 is also good. Similarly, also in FIG. 6A, it is assumed that the propagation state of CH1 in the direction from the wireless transmission device 401 to the wireless transmission device 405 is good and the propagation state of CH2 is poor (not good). Although a specific description is omitted, FIG. 6A illustrates a case where the propagation state of CH1 in the direction from the wireless transmission device 405 to the wireless transmission device 401 is good and the propagation state of CH2 is also good.

For easy understanding, the modulation scheme is 128 QAM as an example.

In general, automatic transmit power control (ATPC) is a function of controlling transmission power of an opposing wireless transmission device so that a received signal level (hereinafter, RSL) does not fall below a certain threshold. The communication quality is secured by the control of the transmission power.

### Operation of Background Art

As an outline, CH1 in a direction from the wireless transmission device 12 to the wireless transmission device 32 in FIG. 8A will be described as an example.

First, the receiver 27 (Rx) of the wireless transmission device 32 detects a received signal level RSL (RL1_21) of the signal (T_RF_CH1_5) received from the opposing wireless transmission device 12.

Next, in the transmission power controller 28 (Tx PWR CNT), the received signal level RSL (RL1_21) is compared with the ATPC threshold under the following conditions, and a control policy for the transmitter 2 of the opposing wireless transmission device 12 is determined based on the comparison result.
RL1_21 > ATPC threshold: Tx Power Down of the transmitter 2 (Tx)
RL1_21 = ATPC threshold: Tx Power Hold of the transmitter 2 (Tx)
RL1_21 < ATPC threshold: Tx Power Up of the transmitter 2 (Tx)

Any one of the above Down/Hold/Up control signals is superimposed and transmitted to CH1′ in the direction from the wireless transmission device 32 to the wireless transmission device 12. In the wireless transmission device 12, the demodulator 6 (DEM) extracts this signal from the reception signal, and controls the transmission power of the transmitter 2 (Tx) for CH1 based on the Down/Hold/Up control signal via the transmission power controller 8 (Tx PWR CNT).

First, in a case where there is no inter-CH cooperation in the ATPC as the background art (see FIGS. 5A to 5C) from the viewpoint of the present invention, the transmission power of CH1 in the transmitter 302 (Tx) in the opposing wireless transmission device 301 is, for example, a Max Power of -10 dB lower by 10 dB than the Max Power of ATPC since the propagation state is good in CH1 and the received signal level RSL in the receiver 306 (Rx) exceeds the threshold of the ATPC.

On the other hand, it is assumed that CH2 has a poor propagation state and the received signal level RSL in the receiver 306 (Rx) is lower than the threshold of ATPC. In that case, in order to maintain a predetermined level of communication quality, it is necessary to increase the transmission power of CH2 in the transmitter 302 (Tx) in the opposing wireless transmission device 301. Here, the transmission power of CH2 is gradually increased in the transmitter 302 (Tx), but even after the Max Power of the ATPC is reached, for example, if the received signal level RSL is lower than the threshold of the ATPC, the transmission power cannot be further increased.

### Operation of Example Embodiment

Next, in the case of the inter-CH cooperation in ATPC which is also the proposed method (see FIGS. 6A and 6B), the transmission power of CH1 in a transmitter 402 (Tx) in the opposing wireless transmission device 401 is, for example, a Max Power of -10 dB lower by 10 dB than Max Power of ATPC because the propagation state is good in CH1 and the received signal level RSL in a receiver 406 (Rx) exceeds the threshold of ATPC.

On the other hand, it is assumed that CH2 has a poor propagation state and the received signal level RSL in the receiver 406 (Rx) is lower than the threshold of ATPC. In that case, in order to maintain a predetermined level of communication quality, it is necessary to increase the transmission power of CH2 in the transmitter 402 (Tx) in the opposing wireless transmission device 401.

In the present example embodiment, since CH1 and CH2 cooperate in the ATPC, even when the transmission power of the own CH becomes the Max Power of ATPC, the transmission power of the own CH can be further increased by +α [dB] from the Max Power of ATPC by adjusting the transmission power level of the other CH.

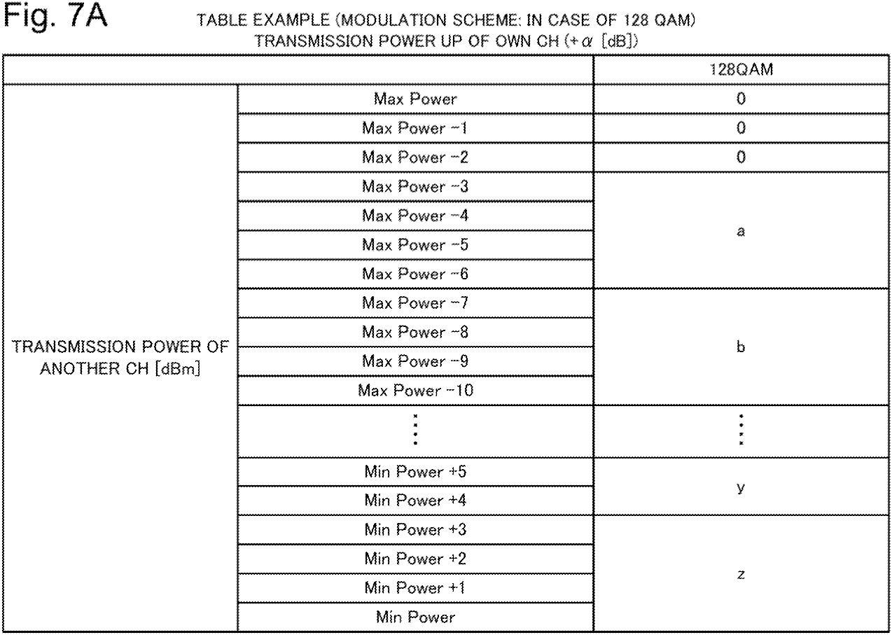

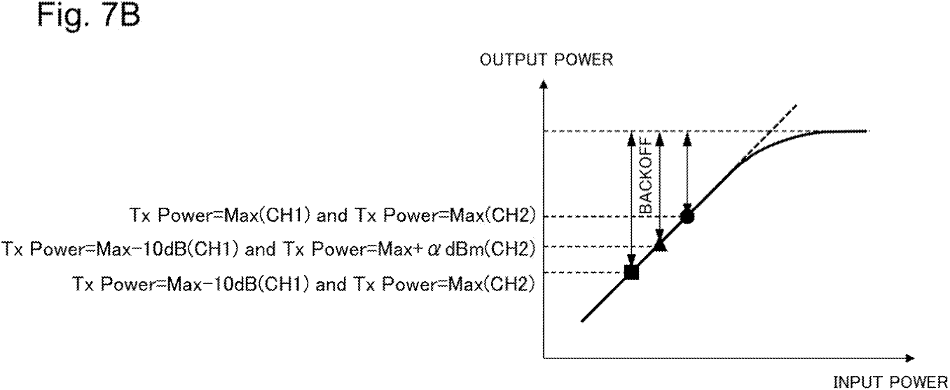

For the increase in transmission power of +α [dB], as an example, a table is prepared in advance for each modulation scheme as illustrated in FIG. 7A. FIG. 7A illustrates an increase in the transmission power of the own CH with respect to the transmission power (Max Power, Max Power -1, ..., Max Power -10, ......, Min Power +5, Min Power +4, ..., Min Power) of the other CH with respect to the modulation scheme: 128 QAM as an example. Here, the numerical values of the increase satisfy z > y >...... > b > a > 0. The numerical values in the table of FIG. 7A are determined by evaluation or the like.

That is, in the transmission power control of the present example embodiment, the transmission power of the own CH can be further increased by +α [dB] than the Max Power of ATPC by providing the own CH with the margin of the backoff caused by the decrease in the level of the other CH. The margin of the backoff caused by the decrease in the level of the other CH is an example of a reserve power up to a maximum value of output power of the other CH. Referring to FIG. 7B, the operating point when the transmission power for CH1 is maximum (Max Power of ATPC) and the transmission power for CH2 is maximum (Max Power of ATPC) is indicated by a symbol “•” (Black Circle). The operating point when the propagation state is good for CH1, the transmission power is a Max Power of -10 dB lower by 10 dB than the Max Power of ATPC, and the transmission power is the maximum (Max Power of ATPC) for CH2 is indicated by a symbol “▪” (Black Square).

In the transmission power control of the present example embodiment, the transmission power of the own CH can be further increased by +α [dB] from the Max Power of ATPC by providing the own CH with a margin of the backoff caused by the decrease in the transmission power of the other CH. The margin of the backoff caused by decrease in the transmission power of the other CH is an example of an example of a reserve power up to a maximum value of output power of the other CH. In FIG. 7B, the operating point when the propagation state is good for CH1, the transmission power is Max Power of -10 dB lower by 10 dB than the Max Power of ATPC, and the transmission power is further increased by +α [dB] from the Max Power of ATPC for CH2 is indicated by a symbol “A” (Black Up-Pointing Triangle). In the symbol “A” (Black Up-Pointing Triangle), it is possible to increase the transmission power for CH2 as compared with the symbol “▪” (Black Square), thereby improving the communication quality for CH2.

As a result of the transmission power control in which CHs cooperate in this manner, the received signal level RSL in the receiver 406 (Rx) of the wireless transmission device 405 can be improved, and the reception characteristics of the system can be improved.

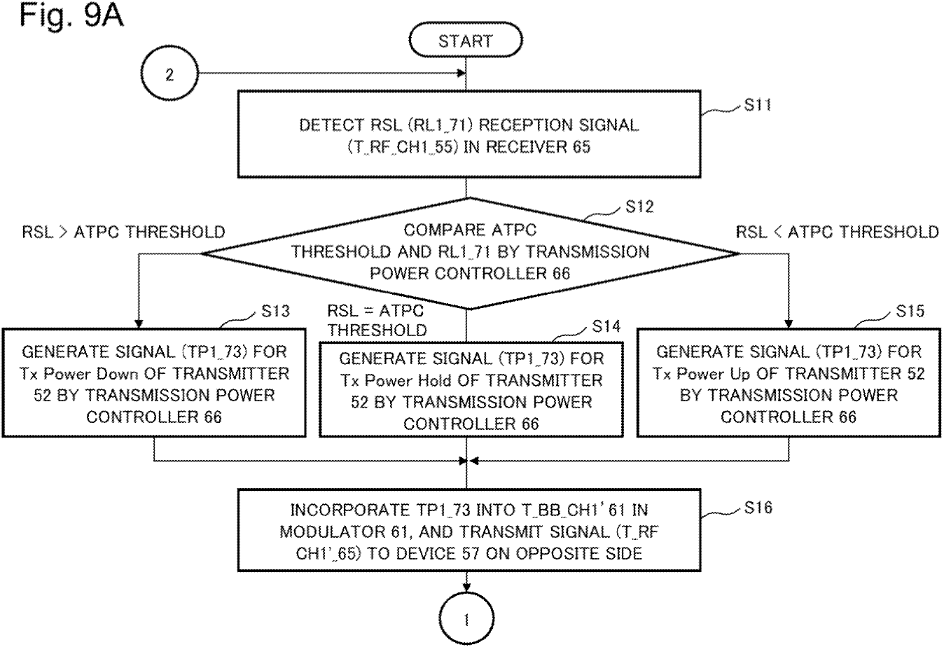

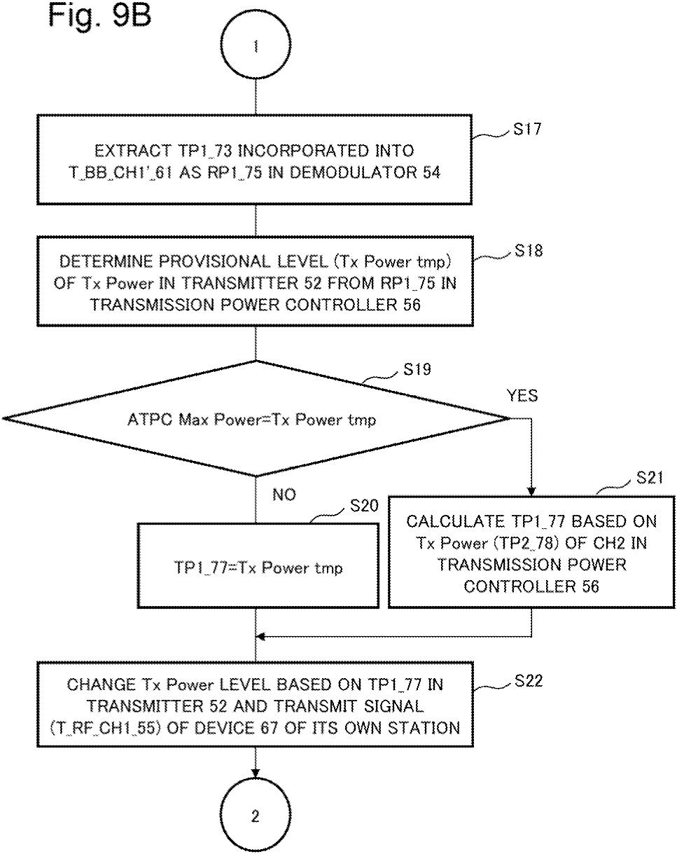

Next, more details of the operation of the present example embodiment will be described based on the flowcharts of FIGS. 9A and 9B and the configuration of FIG. 8B. This flowchart will be described using CH1 in a direction from the wireless transmission device 57 to the wireless transmission device 67 in FIG. 8B as an example.

First, the receiver 65 (Rx) of the wireless transmission device 67 detects a received signal level RSL (RL1_71) of the signal (T_RF_CH1_55) received from the opposing wireless transmission device 57 for CH1 (S11).

Next, the transmission power controller 66 (Tx PWR CNT) of the wireless transmission device 67 compares the received signal level RSL (RL1_71) with the ATPC threshold under the following conditions (S12).
RL1_71 > ATPC threshold: Tx Power Down of the transmitter 52 (Tx) of the wireless transmission device 57
RL1_71 = ATPC threshold: Tx Power Hold of the transmitter 52 (Tx) of the wireless transmission device 57
RL1_71 < ATPC threshold: Tx Power Up of the transmitter 52 (Tx) of the wireless transmission device 57

When the received signal level RSL exceeds the ATPC threshold, the transmission power controller 66 (Tx PWR CNT) generates a signal (TP1_73) for decreasing the transmission power of the transmitter 52 (Tx) of the wireless transmission device 57 (S13), and then the process proceeds to S16. When the received signal level RSL is equal to the ATPC threshold, the transmission power controller 66 (Tx PWR

CNT) generates a signal (TP1_73) for maintaining the level of the transmission power of the transmitter 52 (Tx) of the wireless transmission device 57 (S14), and then the process proceeds to S16. When the received signal level RSL is less than the ATPC threshold, the transmission power controller 66 (Tx PWR CNT) generates a signal (TP1_73) for increasing the transmission power of the transmitter 52 (Tx) of the wireless transmission device 57 (S15), and then the process proceeds to S16.

Next, after the modulator 61 (MOD) of the wireless transmission device 67 incorporates the signal (TP1_73) generated in S13, S14, or S15 into the signal (T_BB_CH1′_61), the transmitter 62 (Tx) transmits the signal (T_RF_CH1′_65) to the opposing wireless transmission device 57 (S16).

Next, in the wireless transmission device 57 that has received the signal from the opposing wireless transmission device 67, the demodulator 54 (DEM) extracts the signal (TP1_73) which is incorporated in the signal (T_BB_CH1′_ 61) as the signal (RP1_75) (S17). Subsequently, the transmission power controller 56 (Tx PWR CTL) of the wireless transmission device 57 determines a provisional level (Tx Power tmp) of the transmission power of the transmitter 52 (Tx) based on the signal (RP1_75) from the demodulator 54 (DEM) (S18).

Subsequently, the transmission power controller 56 (Tx PWR CTL) of the wireless transmission device 57 compares the provisional level (Tx Power tmp) of the transmission power of the transmitter 52 (Tx) with Max Power of ATPC (S19). Here, when the provisional level (Tx Power tmp) of the transmission power of the transmitter 52 (Tx) is not equal to the Max Power of ATPC (No in S19), the signal (TP1_77) is set to the provisional level (Tx Power tmp) (S20), and then the process proceeds to S22. Here, the state in which the provisional level (Tx Power tmp) of the transmission power of the transmitter 52 (Tx) is not equal to the Max Power of ATPC is a state in which the transmission power of channel (CH2) can be increased independently without considering the transmission power of another channel (CH1) when viewed from CH2.

When the provisional level (Tx Power tmp) of the transmission power of the transmitter 52 (Tx) is equal to the Max Power of ATPC (Yes in S19), the transmission power controller 56 (Tx PWR CTL) calculates a signal (TP1_77) based on the transmission power (TP2_78) of CH2 (S21), and then the process proceeds to S22.

Here, the state in which the provisional level (Tx Power tmp) of the transmission power of the transmitter 52 (Tx) is equal to Max Power of ATPC is a state in which the provisional level (Tx Power tmp) of the transmission power for CH2 reaches the upper limit of the transmission power, and the transmission power of CH2 cannot be increased alone. Therefore, when Yes in S19, the signal (TP1_77) is calculated based on the transmission power (TP2_78) of CH1, and then the process proceeds to S22.

Next, the transmitter 52 (Tx) changes the level of the transmission power or maintains the level of the transmission power in response to the signal (TP1_77) from the transmission power controller 56 (TPx PWR CTL), and transmits the signal (T_RF_CH1_55) of the wireless transmission device 57 of its own station to the opposing wireless transmission device 67 (S22). A series of steps of controlling the transmission power is performed regularly or irregularly as necessary. When it is necessary to control the transmission power, after S22, the process returns to S11, and steps S11 to S22 may be performed again.

In this manner, the received signal level RSL of the signal (T_RF_CH1_55) received from the opposing wireless transmission device 57 for CH1 is compared with the ATPC threshold, and the control signal for controlling the transmission power of the transmitter 52 of the opposing wireless transmission device 57 is generated on the basis of the comparison result. The transmission power of the transmitter 52 (Tx) of the wireless transmission device 57 is controlled on the basis of the control signal instructing Down/Hold/Up (Down, Hold or Up).

At this time, when the control signal is Up and the transmission power of the transmitter 52 (Tx) is Max Power of ATPC (Yes in S19), the transmission power level of CH2 in the transmitter 52 (Tx) is checked to determine whether it is possible to further increase Max Power of ATPC by +α [dB].

### Advantageous Effects of the Example Embodiment

In the wireless transmission device and the control method of the wireless transmission device of the present example embodiment, in the case of a system configuration in which one PA (such as the power amplifier 158) is shared by a plurality of CHs, one PA (such as the power amplifier 158) can be covered without using a plurality of CHs, and thus, power consumption of the system can be reduced.

When ATPC is performed in a system configuration in which one PA (such as the power amplifier 158) is shared by a plurality of CHs, the input level of each CH can be optimized with respect to the input level condition of PA by performing transmission power control in cooperation with the plurality of CHs. For example, in the transmission power control of the present example embodiment, it is possible to further increase the transmission power of the own CH by +α [dB] than the Max Power of ATPC by giving the own CH a margin of backoff caused by a decrease in the level of another CH among the plurality of CHs. The margin of the backoff caused by the decrease in the level of another CH is an example of a reserve power up to a maximum value of output power of the another CH. As a result, in a system configuration in which a plurality of CHs share one PA (such as the power amplifier 158), the performance of the PA can be maximized. As a result, in the wireless transmission device of the present example embodiment and the wireless transmission system to which the control method thereof is applied, it is possible to improve the reception characteristics of the entire system.

### Second Example Embodiment

Next, a wireless transmission device and a control method thereof according to a second example embodiment of the present invention will be described. In the first example embodiment described above, the case where the transmission power is controlled in the intermediate frequency (IF) frequency band has been described as an example, but the present invention is not limited to the control of the transmission power in the IF frequency band. In the second example embodiment, transmission power is controlled in a base band (BB) frequency band.

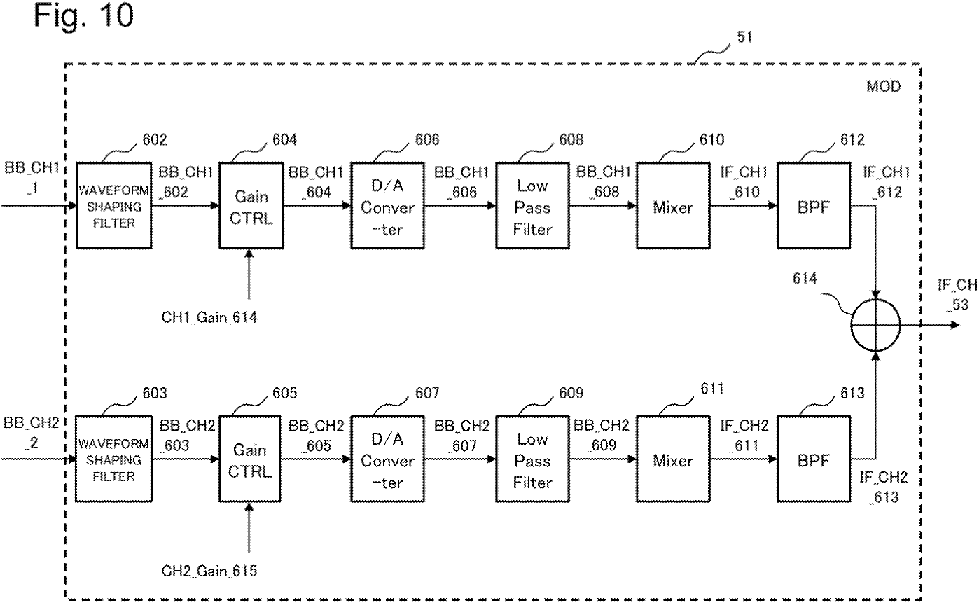

FIG. 10 is a block diagram for describing a configuration example of a transmitter of a wireless transmission device according to the second example embodiment of the present invention. The present example embodiment is characterized by the configuration of the modulator 51 of FIG. 2 on the premise of the wireless transmission device illustrated in FIG. 2 described above.

The present example embodiment relates to a microwave digital wireless communication system that transmits and receives a plurality of radio channels by one antenna, similarly to the first example embodiment described above. In the present example embodiment, as illustrated in FIG. 2, it is assumed that a plurality of channels are transmitted by one wireless transmission device (MOD 51 and Tx 52). Also in the present example embodiment, in the wireless transmission device of FIG. 2, a plurality of wireless channels (CH1, CH2) having different frequency bands are transmitted by one antenna 53.

The wireless transmission device of FIG. 2 includes a modulator 51 (MOD) to which a plurality of input signals (BB_CH1_51, BB_CH2_52) is input, a transmitter 52 (Tx) having a power amplifier, and an antenna 53. The modulator 51 in FIG. 2 adds a plurality of input signals (BB_CH1_51, BB_CH2_52) in the baseband to generate and output an IF signal (IF_CH_53). The transmitter 52 includes a power amplifier, converts an input IF signal (IF_CH_53) into a high frequency band, amplifies the IF signal by the power amplifier, and outputs the amplified IF signal. The antenna 53 transmits the output of the transmitter 52 as a transmission signal (RF_OUT_54) to an opposing wireless transmission device (not illustrated).

Further, in the wireless transmission device of the present example embodiment, the modulator 51 (MOD) is configured as illustrated in FIG. 10. The modulator 51 (MOD) in FIG. 10 includes waveform shaping filters 602 and 603, gain controllers 604 and 605, digital to analog (D/A) converters 606 and 607, and low pass filters 608 and 609. Further, the modulator 51 (MOD) in FIG. 10 includes mixers 610 and 611, band pass filters 612 and 613, and an adder 614.

The modulator 51 (MOD) in FIG. 10 adjusts a gain of an input signal (BB_CH1_1, BB_CH2_2) in a baseband, then converts the signal into an IF frequency band, adds the signals, and then outputs the IF signal (IF_CH_53).

The waveform shaping filters 602 and 603 shape waveforms of input signals (BB_CH1_1, BB_CH2_2) in the baseband to be input. The gain controllers 604 and 605 perform level control of transmission power according to an input control signal (CH1_Gain_614 in the gain controller 604 and CH2_Gain_615 in the gain controller 605). The D/A converters 606 and 607 convert a digital signal into an analog signal. The low pass filters 608 and 609 pass only a signal in a desired low frequency band and cut signals in other frequency bands. The mixers 610 and 611 convert a signal (BB_CH1_608, BB_CH2_609) from the BB band to the IF band. The BPFs 612 and 613 pass only a signal in a desired frequency band. The adder 614 adds the IF signals (IF_CH1_612, IF_CH2_613) associated to the respective channels and outputs the result as an IF signal (IF_CH_53).

In the present example embodiment, similarly to the first example embodiment described above, the receiver (Rx) of the wireless transmission device detects the received signal level RSL of the signal received from the opposing wireless transmission device for CH1, and compares the received signal level RSL with the ATPC threshold. A control signal for controlling transmission power of the opposing wireless transmission device is generated according to the comparison result. Similarly to the first example embodiment, this control signal is a control signal instructing any of Down/Hold/Up (Down, Hold or Up). The transmission power of the opposing wireless transmission device is controlled on the basis of the control signal. In the present example embodiment, the control signal is supplied to the modulator 51 (MOD) in FIG. 2. More specifically, in the present example embodiment, the control signal is provided to the gain controller 604 of the modulator 51 (MOD) in FIG. 10. In the case of controlling the transmission power of the opposing wireless transmission device for CH2, the control signal is provided to the gain controller 605 of the modulator 51 (MOD) in FIG. 10.

In a case where the transmission power of the opposing wireless transmission device for CH1 is controlled according to the above comparison result, the transmission power level of CH2 in the transmitter 52 (Tx) is also checked in the present example embodiment, and it is determined whether the transmission power level can be further increased by +α [dB] than the ATPC Max Power.

### Advantageous Effects of the Example Embodiment

In the wireless transmission device and the control method of the wireless transmission device of the present example embodiment, similarly to the first example embodiment, since one PA (such as the power amplifier 158) can be used without using a plurality of CHs, the power consumption of the system can be reduced.

Further, similarly to the first example embodiment, when ATPC is performed in a system configuration in which one PA (such as the power amplifier 158) is shared by a plurality of CHs, the input level of each CH can be optimized with respect to the input level condition of PA by performing transmission power control in cooperation with the plurality of CHs. Further, similarly to the first example embodiment, in the transmission power control of the present example embodiment, it is possible to further increase the transmission power of the own CH by +α [dB] than the Max Power of ATPC by giving the own CH a margin of backoff caused by a decrease in the level of another CH among the plurality of CHs. The margin of the backoff caused by the decrease in the level of another CH is an example of a reserve power up to a maximum value of output power of the another CH. As a result, in a system configuration in which a plurality of CHs share one PA (such as the power amplifier 158), the performance of the PA can be maximized. As a result, in the wireless transmission device of the present example embodiment and the wireless transmission system to which the control method thereof is applied, it is possible to improve the reception characteristics of the entire system as in the first example embodiment.

Further, in the present example embodiment, transmission power control can be achieved by controlling the gain controller 604 and the gain controller 605 of the modulator 51 (MOD). As a result, in the present example embodiment, the transmission power of the wireless transmission device can be controlled by controlling the BB band signal.

Although the preferred example embodiments of the present invention have been described above, the present invention is not limited thereto. For example, in the first example embodiment and the second example embodiment, the control of the transmission power for CH2 among the plurality of channels (CH1, CH2) has been mainly described, but the control of the transmission power for CH1 can be similarly performed. In FIG. 6A, in a case where the propagation state of CH1 in the direction from the wireless transmission device 401 to the wireless transmission device 405 is poor (not good) and the propagation state of CH2 is good, the transmission power level of CH2 in the transmitter 52 (Tx) may be checked to determine whether the transmission power level can be further increased by +α [dB] than Max Power of ATPC for CH1.

In the first example embodiment and the second example embodiment, the case where the number of the plurality of channels is two (CH1, CH2) has been described as an example, but the number of the plurality of channels to which the present invention is applied may be three or more. In this case, regarding the table illustrated in FIG. 7A, an increase in the transmission power of the own CH may be set for a set of transmission powers of the other CHs (a combination of transmission powers of a plurality of other CHs). Even in a case where the number of the plurality of channels is three or more, it is possible to further increase the transmission power of the own CH by +α [dB] from the Max Power of ATPC by giving the own CH a backoff margin caused by a decrease in the level of at least one other CH. The backoff margin caused by the decrease in the level of at least one other CH is an example of a reserve power up to a maximum value of output power of the at least one other CH. Various modifications are possible within the scope of the invention described in the claims, and it goes without saying that they are also included in the scope of the present invention.

The present invention is applicable to all digital wireless communication systems.

Some or all of the above example embodiments may be described as the following supplementary notes, but are not limited to the following.

(Supplementary Note 1) A wireless transmission device that converts input signals of a plurality of channels into signals of high frequency bands having different frequency bands from each other and then transmits the signals from one antenna, the wireless transmission device including at least:
a modulator to which the input signals of the plurality of channels are input; and
a transmitter that includes a power amplifier and transmits a signal output by the modulator from the antenna, in which
when it is necessary to increase output power of a signal associated to one input signal among the input signals of the plurality of channels and transmitted from the antenna,
reserve power up to a maximum value of output power of another input signal among the input signals of the plurality of channels is checked, and
a control signal is provided to the transmitter or the modulator so as to increase output power of a signal associated to the one input signal within a range of the reserve power and transmitted from the antenna.

(Supplementary Note 2) The wireless transmission device according to Supplementary Note 1, in which

a signal transmitted from the antenna is received, and the control signal associated to a comparison result between a received signal level of the received signal and a threshold is provided to the transmitter or the modulator.

(Supplementary Note 3) The wireless transmission device according to Supplementary Note 1 or 2, in which

the control signal is a signal associated to one of the input signals of the plurality of channels, and performs control to increase, decrease, or maintain output power of a signal transmitted from the antenna.

(Supplementary Note 4) The wireless transmission device according to any one of Supplementary Notes 1 to 3, in which
the input signals of the plurality of channels are intermediate frequency (IF) signals, and
the control signal is provided to the transmitter.

(Supplementary Note 5) The wireless transmission device according to any one of Supplementary Notes 1 to 3, in which
the input signals of the plurality of channels are base band (BB) signals, and
the control signal is provided to the modulator.

(Supplementary Note 6) A wireless transmission system including:
a wireless transmission device according to any one of Supplementary Notes 1 to 5; and
another wireless transmission device that receives a signal transmitted from the wireless transmission device and outputs the control signal.

(Supplementary Note 7) A control method of a wireless transmission device that converts input signals of a plurality of channels into signals of high frequency bands having different frequency bands from each other and then transmits the signals from one antenna, in which
the wireless transmission device includes at least:
a modulator to which the input signals of the channels are input; and
a transmitter that includes a power amplifier and transmits a signal output by the modulator from the antenna, and
when it is necessary to increase output power of a signal associated to one input signal among the input signals of the plurality of channels and transmitted from the antenna,
reserve power up to a maximum value of output power of another input signal among the input signals of the plurality of channels is checked, and
the transmitter or the modulator is controlled so as to increase output power of a signal associated to the one input signal within a range of the reserve power and transmitted from the antenna.

(Supplementary Note 8) The control method of a wireless transmission device according to Supplementary Note 7, in which

a signal transmitted from the antenna is received, and the control signal associated to a comparison result between a received signal level of the received signal and a threshold is provided to the transmitter or the modulator.

(Supplementary Note 9) The control method of a wireless transmission device according to Supplementary Note 7 or 8, in which

the control signal is a signal associated to one of the input signals of the plurality of channels, and performs control to increase, decrease, or maintain output power of a signal transmitted from the antenna.

(Supplementary Note 10) The control method of a wireless transmission device according to any one of Supplementary Notes 7 to 9, in which
the input signals of the plurality of channels are intermediate frequency (IF) signals, and
the control signal is provided to the transmitter.

(Supplementary Note 11) The control method of a wireless transmission device according to any one of Supplementary Notes 7 to 9, wherein
the input signals of the plurality of channels are base band (BB) signals, and
the control signal is provided to the modulator.

Further, it is noted that the inventor’s intent is to retain all equivalents of the claimed invention even if the claims are amended during prosecution.

1. A wireless transmission device that converts input signals of a plurality of channels into signals of high frequency bands having different frequency bands from each other and then transmits the signals from one antenna, the wireless transmission device comprising at least:
a modulator to which the input signals of the plurality of channels are input; and
a transmitter that includes a power amplifier and transmits a signal output by the modulator from the antenna, wherein
when it is necessary to increase output power of a signal associated to one input signal among the input signals of the plurality of channels and transmitted from the antenna,
reserve power up to a maximum value of output power of another input signal among the input signals of the plurality of channels is checked, and
a control signal is provided to the transmitter or the modulator so as to increase output power of a signal associated to the one input signal within a range of the reserve power and transmitted from the antenna.

2. The wireless transmission device according to claim 1, wherein
a signal transmitted from the antenna is received, and the control signal associated to a comparison result between a received signal level of the received signal and a threshold is provided to the transmitter or the modulator.

3. The wireless transmission device according to claim 1, wherein
the control signal is a signal associated to one of the input signals of the plurality of channels, and performs control to increase, decrease, or maintain output power of a signal transmitted from the antenna.

4. The wireless transmission device according to claim 1, wherein
the input signals of the plurality of channels are intermediate frequency (IF) signals, and
the control signal is provided to the transmitter.

5. The wireless transmission device according to claim 1, wherein
the input signals of the plurality of channels are base band (BB) signals, and
the control signal is provided to the modulator.

6. A wireless transmission system comprising:
a wireless transmission device according to claim 1; and
another wireless transmission device that receives a signal transmitted from the wireless transmission device and outputs the control signal.

7. A control method of a wireless transmission device that converts input signals of a plurality of channels into signals of high frequency bands having different frequency bands from each other and then transmits the signals from one antenna,
wherein the wireless transmission device includes at least:
a modulator to which the input signals of the channels are input; and
a transmitter that includes a power amplifier and transmits a signal output by the modulator from the antenna,
wherein, when it is necessary to increase output power of a signal associated to one input signal among the input signals of the plurality of channels and transmitted from the antenna,
reserve power up to a maximum value of output power of another input signal among the input signals of the plurality of channels is checked, and
the transmitter or the modulator is controlled so as to increase output power of a signal associated to the one input signal within a range of the reserve power and transmitted from the antenna.

8. The control method of a wireless transmission device according to claim 7, wherein
a signal transmitted from the antenna is received, and the control signal associated to a comparison result between a received signal level of the received signal and a threshold is provided to the transmitter or the modulator.

9. The control method of a wireless transmission device according to claim 7, wherein
the control signal is a signal associated to one of the input signals of the plurality of channels, and performs control to increase, decrease, or maintain output power of a signal transmitted from the antenna.

10. The control method of a wireless transmission device according to claim 7, wherein
the input signals of the plurality of channels are intermediate frequency (IF) signals, and
the control signal is provided to the transmitter.

11. The control method of a wireless transmission device according to claim 7, wherein
the input signals of the plurality of channels are base band (BB) signals, and
the control signal is provided to the modulator.
